(19) United States
(12) Patent Application Publication
(10) Pub. No.: US 2003/0037580 A1
(43) Pub. Date: Feb. 27, 2003

(54) Attachment device

(76) Inventor: Graeme Ashley Blake, Hamilton (NZ)

Correspondence Address: YOUNG & THOMPSON, 745 SOUTH 23RD STREET 2ND FLOOR, ARLINGTON, VA, 22202

(21) Appl. No.: 10/221,648

(22) PCT Filed: Mar. 9, 2001
(86) PCT No.: PCT/NZ01/00038

(30) Foreign Application Priority Data
Mar. 14, 2000 (NZ) 503361

(51) Int. Cl. E05B 19/04

(52) U.S. Cl. 70/408

(57) ABSTRACT

The present invention relates to an attachment device for keys which includes a securing means by which the shaft of the key can be secured and joining mechanism (5,6) configured to join with the joining mechanisms (5, 6) on like attachment devices. The present invention can be configured into a variety of shapes thus making it given the opportunity for the attachment device to act as a promotional vehicle. Likewise, the attachment device can receive print, again making it a promotional vehicle.

### TECHNICAL FIELD

The invention relates to an improved attachment.

More particularly the present invention relates to improvements in organising articles such as keys in an orderly fashion.

### BACKGROUND ART

Many objects such as keys, Allen keys, and so forth are kept together on one device. In the case of keys, key rings are usually employed to keep keys in a bundle. Unfortunately these devices can easily become tangled. Further, it can be difficult to locate a particular key in a bunch of keys quickly due to the similarity in types and colours.

Another problem with traditional key rings is that they often have a split ring configuration. This configuration is difficult to add new keys to, or remove from, which can be frustrating for the owner of the keys.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided an attachment device for keys which includes

securing means by which the shaft of a key can be secured, and

a joining mechanism configured to join with joining mechanisms on like attachment devices.

The securing means may come in a number of forms, but its main function is to ensure there is a means by which the key shaft can be held.

An embodiment of the present invention whereby the attachment device is OEM (Original Equipment Manufacturing), the securing means may be in the form of a key head integrally moulded around a key shaft.

However in other embodiments of the present invention the securing means may be able to receive and hold the existing head of a key.

For example, the securing means may include two halves hingedly attached with an aperture in the hinged area through which the shaft of the key can pass when the securing means is in an open position. Securing means could then be closed to then hold the head of the key and providing a means by which the shaft of the key can be secured and readily used.

Other embodiments of securing means may include two separate halves which can be clamped over the top of an existing key head. There may be other embodiments which may achieve the same function through different means.

In one embodiment the securing portion may snap lock together, although other configurations such as a bayonet clip, screw and thread combination, magnet and so forth can be used.

In preferred embodiments, the joining means forms part of the securing means and is positioned at the end of the attachment device distal to the key shaft.

The joining means may come in a number of forms, but in preferred embodiments the joining means is in a form that enables the attachment device to be releaseably attached to like attachment devices.

This may be achieved by a variety of means. In one embodiment, the joining means may be in the form of a releasable adhesive or perhaps even a hook and pile fastening such as Velcro™.

Preferably however the joining means is in the form of complementary lugs and recesses made in such a way that the attachment devices can be pushed to join together or readily pulled apart.

While the attachment device can be made of any suitable material, in preferred embodiments it is made of plastic which is capable of slight deformations which can aid in the holding together of the securing portion and the attachment and release of the joining means.

Plastics material also allows the attachment devices to be colour coded making for ready selection of the appropriate key.

The applicant has recognised that it is preferable that keys joined together can move in relation to each other to enable one key to be readily selected from the others. Thus, in the preferred embodiment of the present invention the joining means is substantially circular, thus allowing the attachment devices joined together to rotate with respect to each other around the joining means—thus enabling one key to be easily swung out of the bunch.

It is possible that certain designs of the present invention may required additional assistance in securing the head of the key in relation to the attachment device. Thus, there may be within the attachment device packing material, foam, adhesive and so forth which can prevent the key head and/or shaft moving relative to the attachment device.

The attachment device may come in a number of shapes, although it is envisaged that a portion of the attachment device closest to the key shaft is a similar size and shape (may be slightly larger) than a key head.

If the present invention is OEM manufactured, the user of the key will still need a gripping portion to operate the key shaft. If the present invention is to be used to enclose existing key heads, then this needs to be accommodated within the attachment device.

In some embodiments of the present invention the attachment device may be custom made. This means that the shape of the device may vary according to the customer for whom it is intended or the organisation providing the attachment device. Thus, the present invention can be used as a promotional vehicle.

As an example of how the present invention can be used as a promotional vehicle, the attachment device could take the form of a character, cartoon outlines, vehicle outlines and so forth.

Each attachment device may take on separate characteristics which have a common theme so that when attachment devices are placed together that theme is realised. For example, attachment devices may each be a different component of a hamburger which when they are together makes a full hamburger.

It is preferable that the material from which the attachment device is made can receive print, which again affords the opportunity user of the present invention as a promotional vehicle.

As it can be seen, there is provided a ready means by which keys can be joined directly together in a tidy arrangement which stills allows keys to be selected.

Some embodiments may have an aperture through the attachment device so that a string, chain or some other length of material (even a split ring) can be placed there through.

In some embodiments there may be provided a mounting rack into which the attachment device can be placed to allow a ready storage if the keys were not in use.

There may be provided an adapter on the attachment device, just in case there is a key which may not fit within the attachment device but can still be attached to the main bunch of keys associated with attachment devices.

It should be appreciated that the present invention has a number of advantages over the prior art.

Firstly, there is provided a ready way by which keys can be attached to each other without the problems associated with having keys on devices such as split rings.

The keys are readily accessible and will not become tangled as in the case of prior art keys.

Keys can be readily selected as they are connected together in an ordered way and may be colour coded.

In embodiments that are not OEM manufactured, the present invention can be used with keys of a variety of shapes and confer some consistency to the traditional bunch of keys.

The present invention also provides a ready way by which promotional material can be displayed.

### BRIEF DESCRIPTION OF DRAWINGS

Further aspects of the present invention will become apparent from the following description which is given by way of example only and with reference to the accompanying drawings in which:

FIG. 1 shows an exploded view of one embodiment of the present invention; and

FIG. 2 shows a plan view of one embodiment of the present invention; and

FIG. 3 shows an adapter according to the present invention; and

FIG. 4 shows a rack according to one aspect of the present invention; and

FIG. 5 illustrates one aspect of the present invention receiving a key head, and

FIG. 6 shows an illustration of a preferred embodiment attached to other preferred embodiments in a bunch, and

FIGS. 7 & 7A show an illustration of a preferred embodiment integrally formed with a key, and

FIG. 8 shows an embodiment of the present invention with an aperture through the couple, and

FIG. 9 shows a further preferred embodiment.

FIG. 10 shows a further embodiment.

### BEST MODES FOR CARRYING OUT THE INVENTION

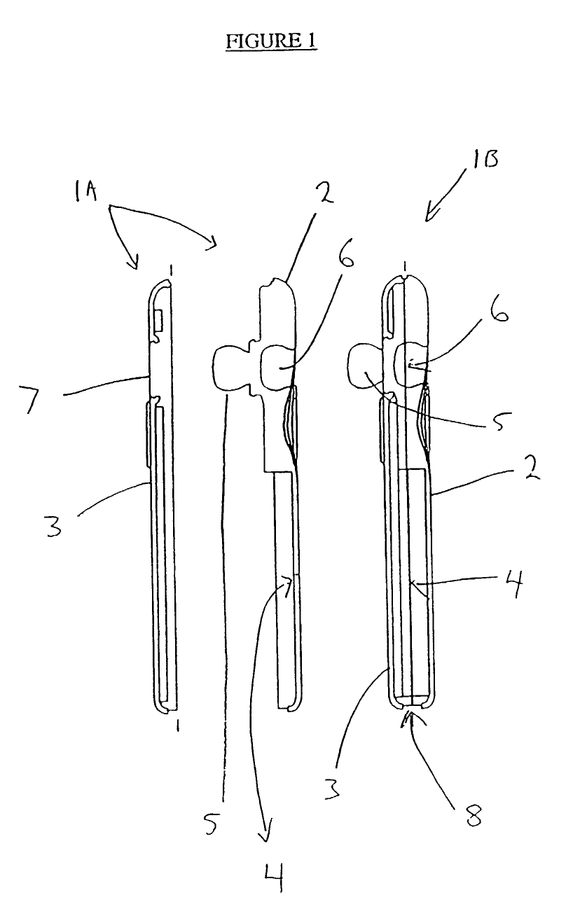

With reference to FIG. 1 there is shown a side on view of one aspect of the present invention. The arrangement 1A is an exploded view of that of 1B.

The receiver 2 fits to a lid 3.

The receiver 2 has a receiving recess 4 adapted to receive for example a key head.

Other objects may be received by the receiver 2, depending on its configuration within the scope of the present invention.

A male member 5 of a snap lock couple is formed on one side of the receiver 2, and will protrude through the hole 7 of the lid once the lid 3 is snapped into place.

A female recess 6 of the snap lock couple is formed on the opposite side of the receiver 2 to the male part 5.

The female recess 6 is adapted to receive the male member 5 of a like device.

An aperture 7 is provided at the end of the assembled apparatus 1B, for the coded portion of the key to protrude therefrom.

The present invention is designed so that a number of like devices can be removeably attached together using the mating couple, to allow a plurality of keys to be stored conveniently.

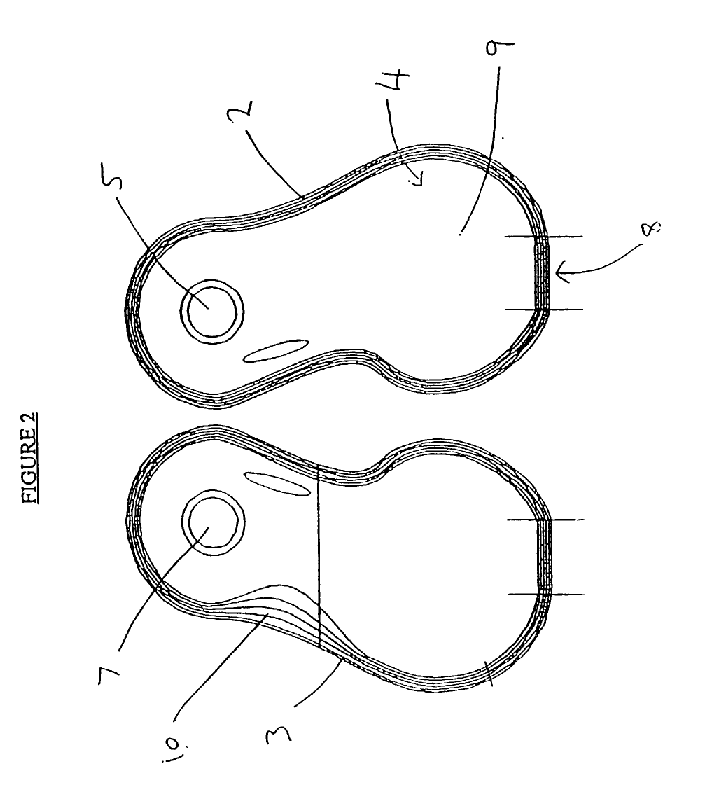

With reference to FIG. 2 there is shown a plan view of the receiver 2 and the lid 3.

The receiving portion 4 may include at 9, an attachment means such as a die cast adhesive foam, to assist in the securement of the key head in the receiver.

A thumb gap 10 is provided to permit easy access to the particular device containing the desired key, and also to aid in the separation of the receiver and the lid.

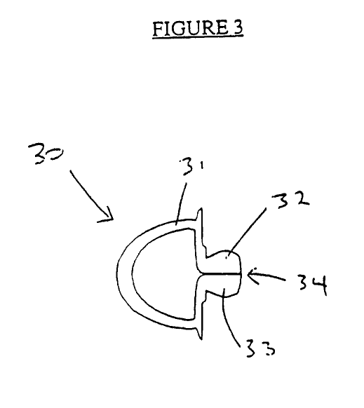

With reference to FIG. 3, there is shown a further aspect of the present invention in the form of an adapter. The adapter is designed to allow attachment of keys that do not fit into the receiving portion of the receiver.

The adapter 30 is effectively a loop 31 that includes ends 32 and 33 that collectively perform the equivalent of the male member 5 in FIG. 1 and FIG. 2. The ends 32 and 33 may be separated, to allow fitment through a hole in the key head. The key head is then secured and may move about the loop 31. The male member 34 may then be attached to a device as shown in FIG. 1 or 2, or 4.

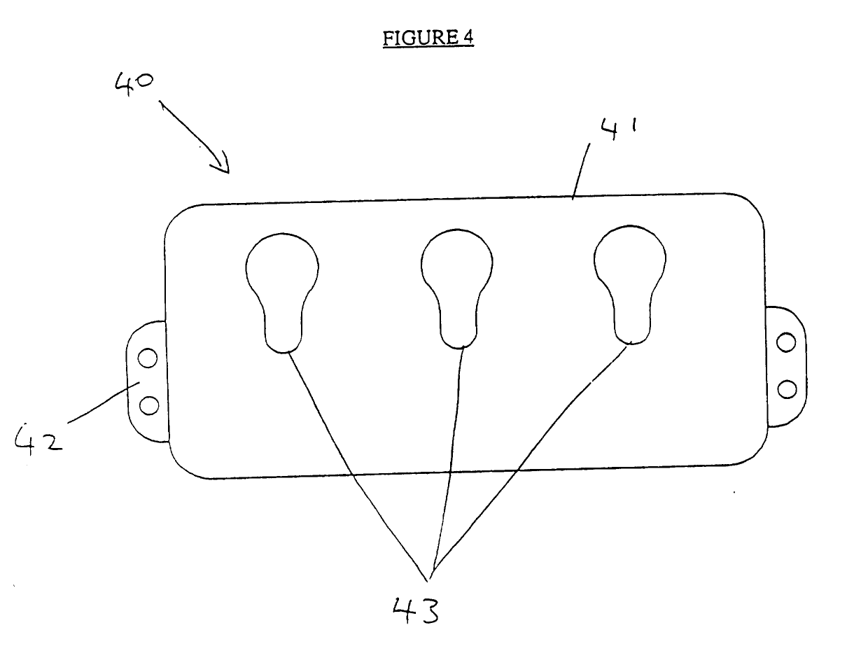

With reference to FIG. 4, there is shown a rack 40 configured to allow convenient storage of the devices shown in FIGS. 1, 2 and 3.

The rack 40 includes a face 41 with brackets 42 for fitment to a wall or the like.

Openings 43 are provided that are adapted to receive the male member 5, or 34, of the devices shown in FIGS. 1, 2 and 3. The male member 5 or 34 may fit into the wider part of the apertures 43 and then slot into the narrow part securing the arrangement in place.

With reference to FIG. 5, there is shown a receiver 2 as depicted in FIGS. 1 and 2, which has in the recessed area 4 a key head 50 with the coded portion 51 of the key 50 protruding through the recess 7.

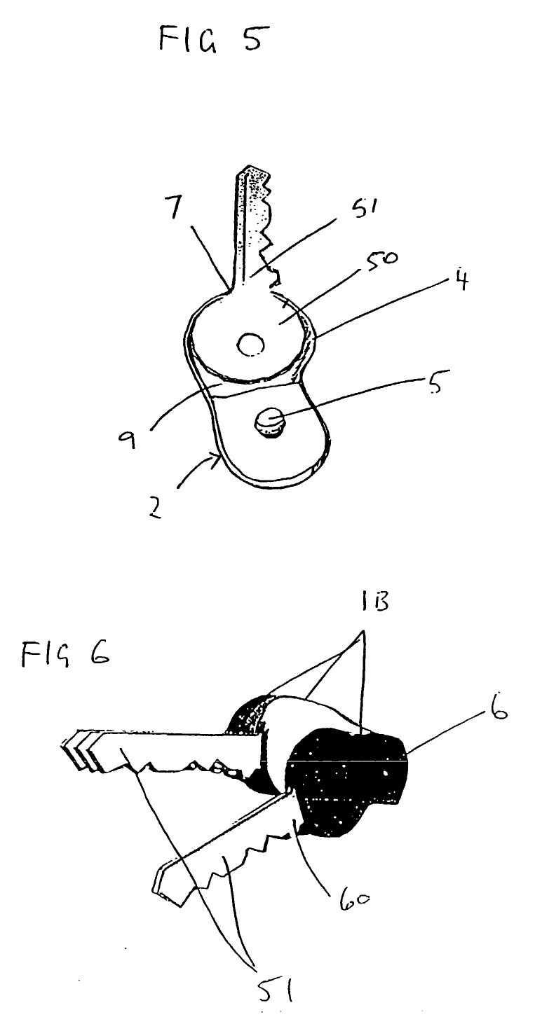

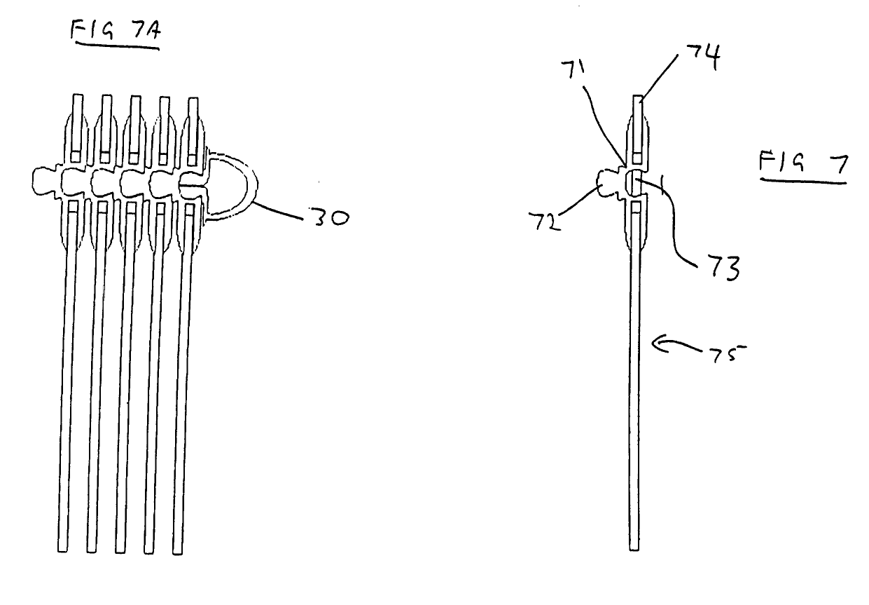

With reference to FIG. 6, there is shown a plurality of preferred embodiments according to those shown in FIGS. 1, 2 and 5 that have been coupled together using the snap lock couples, with the coded section 51 of the keys protruding therefrom. The key 60 that has been swivelled downwards illustrates how the present invention may be used to easily store and access a bunch of keys. The key 60 is singled out from the rest of the bunch of keys, and can then be used conveniently and easily.

A further like device could be attached to the female couple 6, increasing the size of the bunch of keys 51.

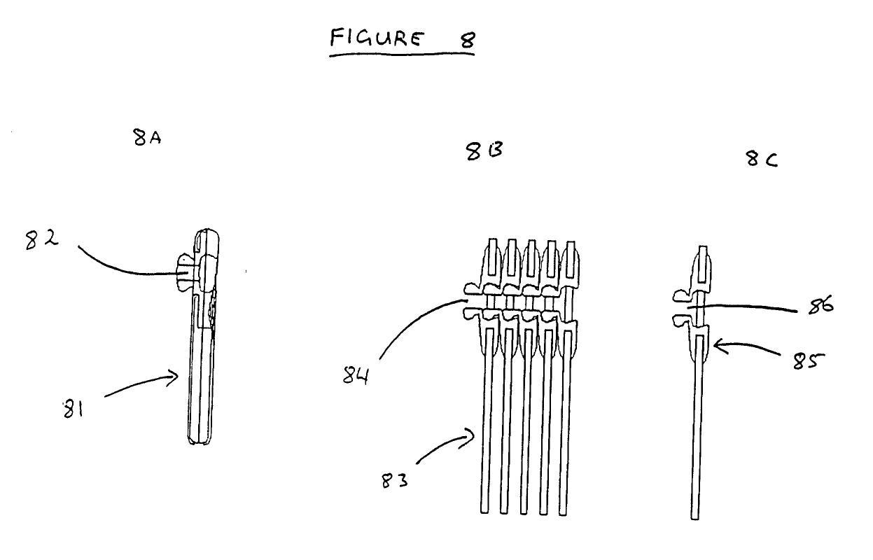

With reference to FIG. 7, there is shown a side on view of a further aspect of the present invention shown by general arrow 70.

The receiver 71, which includes male member 72 and female recess 73 formed therein, is integrally formed around the head 74 of the key 75. The female recess 73 is located in this embodiment, through the centre of the key 75.

In this fashion, keys may be manufactured with the present invention pre-moulded around them enabling like keys to be fitted together in a bunch according to the present invention, with the aforementioned advantages.

This is an alternative embodiment of the present invention whereby a consumer does not need to purchase an after market product to enjoy the benefits of the present invention, as the present invention was already pre-moulded about the object, a key head in this example.

FIG. 7A shows a plurality of keys shown in FIG. 7 joined together in a bunch in accordance with the present invention. The adapter 30 shown in FIG. 3 is shown attached to the right most key of the bunch.

With reference to FIG. 8 there is shown further embodiments of the present invention, whereby an aperture is formed through the couple arrangement.

This will allow multiple devices according to the present invention to be secured with a conventional key ring or chain.

FIG. 8A shows a representation 81 of the embodiment represented in FIG. 1 previous, but with the addition of aperture 82 through the couple.

FIG. 8B shows a representation 83 of the embodiment in FIG. 7A previous which is a plurality 83 of the embodiment 85 in 8C connected together forming a continuous aperture 84 that is formed through the adjacent couples. FIG. 8C shows a single element as previously represented in FIG. 7, but having aperture 86 formed through the couple.

The apertures may be used to place a key chain, string, rope or some other securing length there through to secure the bunch.

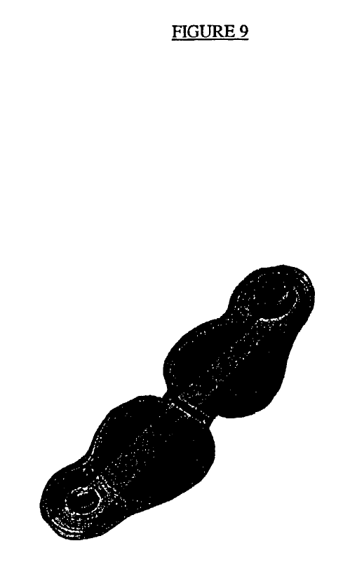

With reference to FIG. 9 there is shown a further embodiment of the present invention. The embodiment shown in FIG. 9 is largely the same as that shown in FIG. 1.

The embodiment of FIG. 9 shows two identical halves 90 and 91 forming a lid and a receiver. The halves 90 and 91 are joined by a hinge 92 which forms a gap 93 there between. When the halves 91 and 92 are folded and closed against one another, the gap 93 is adapted to fit the shank of a key there through. The receiving portions 94 of the halves 90 and 91 are adapted to receive the head of a key.

A couple arrangement having a female part 95 adapted to receive a male part 96 are on either half 90 and 91. They are configured so the male part will mate with the female part of a like device.

A snap lock arrangement shown by protrusions 97 that fit and snap lock into recesses 98 may be provided to retain the receiver and lid against one another.

In some embodiments however the point where the male and female couples 95 and 96 are situated may be a simple aperture instead.

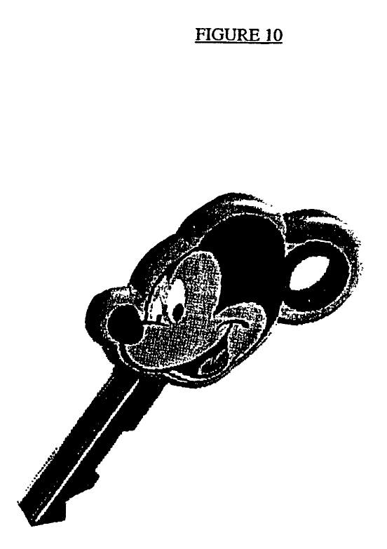

With reference to FIG. 10, there is shown a further embodiment or possible use of the present invention.

The outline of the present invention may be configured so that it is in the shape of a cartoon character. The embodiment of FIG. 10 shows the invention 100 closed up with a key shank 101 protruding therefrom.

The outline of the present invention could be configured to conform to other shapes as desired.

Aspects of the present invention have been described by way of example only and it should be appreciated that modifications and additions may be made thereto without departing from the scope of the appended claims.

1. An attachment device for keys which includes:
securing means by which the shaft of a key can be secured, and
a joining mechanism configured to join with joining mechanisms on like attachment devices.

2. An attachment device as claimed in claim 1 which is original equipment manufactured in the form of a key head integrally moulded around a key shaft.

3. An attachment device as claimed in claim 1 wherein the securing means can receive and hold the existing head of a key.

4. An attachment device as claimed in claim 3 wherein the securing means includes two halves hingedly attached with an aperture in the hinged area through which the shaft of the key can pass when the securing means is in the open position.

5. An attachment device as claimed 1 or claim 3 which includes two separate halves which can be clamped over the top of an existing key head.

6. An attachment device as claimed in any one of claims 3 to 5 wherein the securing portion may snap lock together.

7. An attachment device as claimed in any one of claims 1 to 6 where a joining means forms part of the securing means and is positioned at the end of the attachment device distal to the key shaft.

8. An attachment device as claimed in any one of claims 1 to 7 where a joining means is in the form of complementary lugs and recesses which enables the attachment devices to be pushed to join together or readily pulled apart.

9. An attachment device as claimed in any one of claims 1 to 8 wherein the joining devices substantially allow the attachment devices joined together to rotate with respect to each other around the joining means.

10. An attachment device as claimed in any one of claims 1 to 10 which is shaped in order to enable the attachment device to act as a promotional vehicle.

11. An attachment device as claimed in any one of claims 1 to 10 wherein the attachment device can receive print.

12. An attachment device substantially herein as described with reference to and is illustrated by the covering drawings.
